(19) United States
(12) Patent Application Publication
(10) Pub. No.: US 2025/0111359 A1
(43) Pub. Date: Apr. 3, 2025

(54) SYSTEM AND METHOD FOR SPECIAL PURPOSE VIRTUAL SPLIT-ACCOUNTS

(71) Applicant: Source Ltd., Valletta (MT)

(72) Inventors: Shmuel UR, Shorashim (IL); Orly SHARON, Rehovot (IL)

(73) Assignee: Source Ltd., Valletta (MT)

(21) Appl. No.: 18/477,666

(22) Filed: Sep. 29, 2023

(51) Int. Cl. G06Q 20/38

(52) U.S. Cl. CPC G06Q 20/389

(57) ABSTRACT

Embodiments of the present invention include systems and methods for managing transfers among nodes (e.g. computer systems) including for example, in a computer system including associated transferring nodes each comprising processors; a first transferring node comprising a processor; and a managing node comprising a processor: determining, based on a rule or parameters governing an account associated with the associated transferring nodes, what proportion of a transfer each associated transferring node is to transfer; the managing node effecting a transfer between the associated transferring nodes and the first transferring node. The nodes or computer systems may be associated with accounts.

### FIELD OF THE INVENTION

The present invention relates to the field of electronic communications and transactions, for example, payments by a number of individual users who share expenses or revenues.

### BACKGROUND OF THE INVENTION

For various electronic communications which may be unitary in the prior art, e.g. between one party A and a second party B, it may be desirable for the communications to be divided such that more than one party takes part on either or both sides. For example, parties may want to agree to share expenses and/or revenues. In the prior art, this may be done employing various non-technical arrangements. In some arrangements, parties may agree to pay expenses equally in a 50 percent/50 percent arrangement. In other arrangements, parties may agree to pay expenses in unequal portions or shares, such as a 50 percent/25 percent/25 percent arrangement. In other arrangements, revenues as well as expenses may be apportioned in a percentage basis, e.g. equal or unequal. In other arrangements, the revenue apportionment percentage arrangement may be different from the expense apportionment percentages. The complexity of such arrangements increases dramatically as the number of participants increases and the number of percentages increases proportionally. The prior art provides no way to easily and automatically allow more than one party on a side to participate easily and seamlessly in such communications.

### SUMMARY OF THE INVENTION

Embodiments of the present invention include systems and methods for managing transfers among nodes (e.g. computer systems) including for example, in a computer system including associated transferring nodes each comprising processors; a first transferring node comprising a processor; and a managing node comprising a processor: determining, based on a rule or parameters governing an account associated with the associated transferring nodes, what proportion of a transfer each associated transferring node is to transfer; the managing node effecting a transfer between the associated transferring nodes and the first transferring node. The nodes or computer systems may be associated with accounts. Transfers or transactions may include a transfer of resources such as computing resources, funds, or other resources.

Embodiments of the invention may provide the mechanism to split previously unitary communications, and methods to document and enforce such arrangements. Embodiments include a new and novel system and method of creating virtual special purpose account to serve multiple parties. Embodiments may enable multiple users to for example pay shared expenses revenues received based on predetermined percentage or proportions agreed on and assigned prior agreement of the users. Embodiments may support reporting results, multiple authorization schemes, inter-account lending, and deferred payments.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a high-level diagram illustrating an example configuration of a system for managing transactions using split accounts, according to at least one embodiment of the invention.

FIG. 2 is a high-level block diagram of an exemplary computing device which may be used with embodiments of the present invention.

FIG. 3 is a flow chart of the establishment and use of a Virtual Split Account (VSA) or central account, according to some embodiments of the invention.

FIG. 4 presents an example information flow according to some embodiments.

FIG. 5 depicts a graph depicting example payments to a first transferring node, e.g. a merchant controlling a merchant account.

FIG. 6 depicts communications among entities according to embodiments of the invention.

FIG. 7 depicts a graph depicting example payments to a first transferring node, e.g. a merchant controlling a merchant account.

FIG. 8 depicts communications among entities according to embodiments of the invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the detailed description herein, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

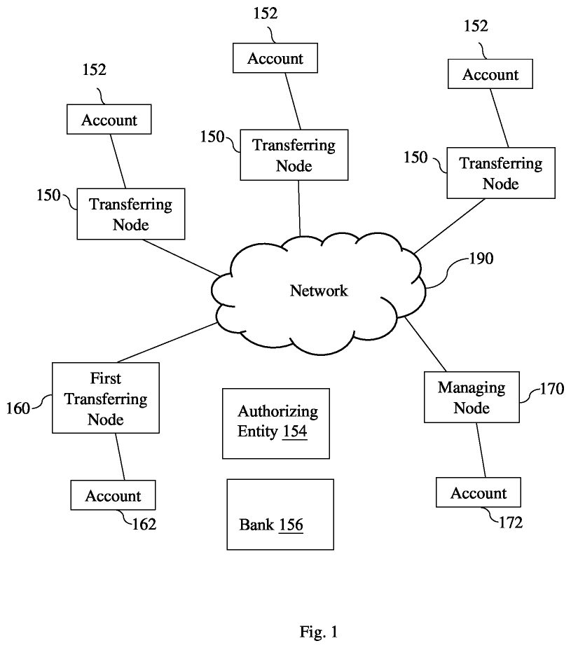

FIG. 1 shows a high-level diagram illustrating an example configuration of a system for managing transactions using split accounts, according to an embodiment of the invention. A number of associated transferring nodes 150 each may be a computer system disparately geographically located from each other. In one embodiment a transferring node is a computing system or organization owning or controlling computing resources, e.g. entitled to use of such resources on a remote cloud platform. Each node 150 may control a local account 152 (which also may be called a local VSA account) owned by the owner or operator of the transferring node, or may control another system or device which is to conduct or participate in a transfer. Users or owners of transferring nodes 150 may for example be people controlling or owning accounts 152 (e.g. bank accounts, credit card accounts, accounts tracking computing resources, etc.). A transferring node 150 may be a smartphone, personal computer, server, tablet, workstation, etc. A first transferring node 160 may be a computer system disparately geographically located from the associated transferring nodes and may control a local account 162 owned by or associated with the owner or operator of the first transferring node, or may control another system or device which is to participate a transfer. A first transferring node 160 may be a smartphone, personal computer, tablet, etc., and in the case that the operator or owner of first transferring node 160 is an institution (e.g. a merchant, a bank, etc.) may be a server.

A managing node 170 may be a computer system disparately geographically located from other nodes and may control a shared or central account 172, e.g. a VSA, owned by or associated with the owner or operator of managing node 170. Managing node 170 may be a server, or another computer system such as a smartphone, personal computer, tablet, etc. Managing node 170 may direct and control transfers, data exchanges, or other communications among nodes 150 and 160, store or configure user or account information and permissions, generate reports, and receive and coordinate transfers. For example, managing node 170 may, using a processor, determined for a transfer proportions to transfer to or from other nodes, effect the transfer, e.g., manage transfers involving funds among accounts 152, 162 and 172, perform global or local optimizations, request or handle permissions or authorizations, send a request to transfer to participants, record transactions in a blockchain structure etc. Central account 172, e.g. a VSA, is shown in one example being managed or maintained by a managing node, which may be separate from other nodes 150 and 160, but in other embodiments central account 172 may be controlled or maintained by nodes that make use of account 170 such as nodes 150 and 160.

An account as used herein may be, for example, a data structure keeping track of objects, computational resources, possessions, or intangible owned objects such as funds. For example, an account may be a record kept in a blockchain structure, a record keeping track of computations or other computer resources that can be split among devices, a bank account or a financial account held by another institution, a record of other objects, such as seeds, government food vouchers, etc. For example, in one embodiment computers in a server farm may use accounts as described herein such that if computer A needs to use processing power resources, or other resources (e.g. memory, storage resources, time on a VMS (virtual machine system or virtual memory system)), from computers B and C, accounts may be used to organize the transitioning of computer processing power. For example computer B may provide 25% of the needed processing power to computer A, and computer C may provide 75% of the needed processing power to computer A. A virtual account may keep track of these resources. In another embodiment, an entity may use such accounts to purchase X hours of processing on a computer. In an embodiment that account tracks remote computer resources, e.g. processing or storage (e.g. remote from a computing entity assigned to or “owning the resource”, such an entity typically remote from a physical cloud facility). An entity may obtain remote storage or give another entity the right to use its remote storage. Such exchanged storage may be encrypted so other entities may use a first entity's storage but each cannot know the other has stored there, or so the receiving or obtaining party's data cannot be seen by the providing party.

Nodes 150, 160 and 170 may communicate with each other and other devices via network 190, which may be for example the internet. While nodes 150, 160 and 170 may be separate computing nodes or computers, the functionality of these nodes may be distributed elsewhere; for example the functionality of nodes 150, 160 and 170 may be in the cloud, e.g. a software and data hosting center. Each of accounts 152 may for example keep track of resources such as computing resources (memory, processing power, etc.), money, or other resources. Each of accounts 152 may be connected to other infrastructure which may keep track of such resources, such as an authorizing entity 154, bank 156, or other infrastructure, which for clarity is shown connected to only one of accounts 152.

Embodiments may be implemented e.g. as a stand-alone app executed by one of nodes 150. 160 and 170 or may be used in connection with a financial institution's executed software or as an add-on to a pre-existing financial account software such as, but not limited to that provided by the Paypal service, the Venmo service and the like. Embodiments may also reside in the Cloud (e.g. software, processing capability and data hosted by a third party for multiple customer parties, at a data center or server farm or the like, remote from the customer parties). Embodiments may operate in a password protected environment with a user ID (identification) and password regime or may use any other system of authentication, for example biometric authentication, or other systems.

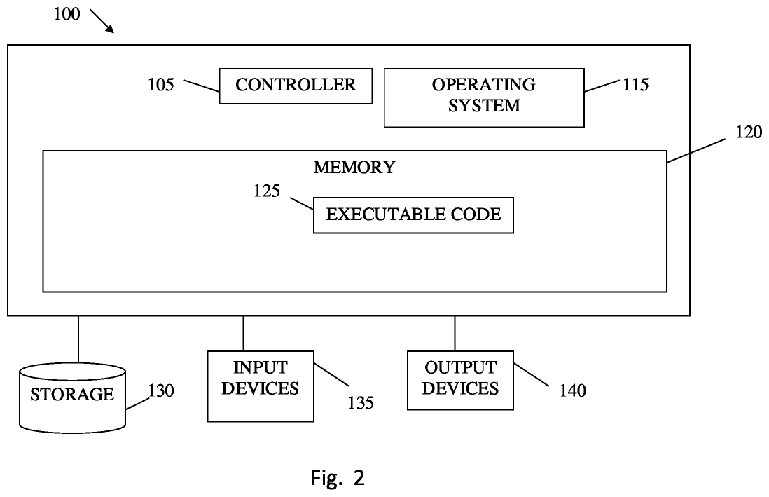

FIG. 2 is a high-level block diagram of an exemplary computing device which may be used with embodiments of the present invention. For example, any of the units in FIG. 1 such as nodes 150, 160 and 170, a cloud computing processor, or other modules may be a computing system as in FIG. 2. Referring to FIG. 2, computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or data such as transfer data, account data, etc.

Executable code 125 may be any application, program, process, task or script. Executable code 125 may be executed by controller 105 possibly under control of operating system 115. For example, executable code 125 may be one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a Compact Disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Various technologies may be used to implement embodiments of the invention and may be improved by embodiments of the invention. For example, one embodiment may integrate accounts as discussed herein with digital ledger technology (DLT, e.g. Blockchain), smart contracts and secure multiparty computation technology. A blockchain is a type of Digital Ledger Technology (DLT) which keeps track of data (e.g. accounts as described herein) using a growing list of records, called blocks, that are securely linked together using cryptography. Each block may include data such as a cryptographic hash of the previous block, a timestamp, and transaction data (e.g., represented as a Merkle tree, where data nodes are represented by leaves). Each block may include information about the block previous to it, to form a chain. Blockchain transactions or transfers may be irreversible in that, once they are recorded, the data in any given block cannot be altered retroactively without altering all subsequent blocks.

A smart contract is a computer program or a transaction protocol that automatically executes, controls or document events according to the terms of a contract; this may reduce the need for third party mediators and other requirements such as arbitrations costs, fraud losses, etc. Secure multi-party computation (also known as secure computation, multi-party computation (MPC) or privacy-preserving computation) is a cryptography technology which may allow entities to jointly compute a function over their inputs while keeping those inputs private from other participating parties.

Accounts as discussed herein may be used to keep track of resources such as agricultural resources, computing resources, financial resources, etc. In one example, three parties have agricultural fields, and buy resources for use in those fields. The three parties would like to buy together as a group, to lower costs (e.g., one delivery, a size discount, etc.). Party A has 48% of the total size of the fields, party B 22% and Party C 30%, which is also the split in resources and payment. If the parties want to use embodiments of the present invention so that when one party wants to execute a join purchase of resources, that party may sends a request which may (per pre-set parameters) need the approval of the other two, and payment from the other two. The request is made and the resources delivered according to predefined software. For example, fuel may be delivered to one place, seeds to another, and fertilizer taken from a third.

An embodiment using VSAs in conjunction with blockchain and smart contract technologies, may provide functionality such that when any one party initiates a request, the blockchain and other code is executed (e.g. via systems 150, 160 and 170 in Fig.) according to the request (e.g., the smart contract), and the appropriate approvals are sent, and when received the appropriate actions are taken. Thus a transfer or request for transfer may be embodied in a smart contract. Secure multi-party computation may be used so that each party does not see information belonging to the other nor impact the result of the computation for others in any way.

In one example using blockchain technology, if party A initiates a buy fuel computation, the initiation has an amount of fuel and date. If the amount is for example 1,000 gallons and the date of the transaction is Oct. 22, 2023, with the smart contract, request for approval is sent to parties B and C and may include the amount (480 gallons for party B) the date Oct. 22, 2023 and the cost of this future which the smart contract finds in the place designated for it (for example, $657). Once parties B and C approve, the smart contract causes the various systems to take the money from all, execute the future transaction, and place the order location at Shmuel, as decided initially for this smart contract. The entire computation may be executed with multi-party computation so that each of the people does not impact the agreement nor get information from the other.

In one example using blockchain technology, the VSA receives an offer from a harvester to cut 10 acres of wheat on the Oct. 19, 2023, and takes 1/5 of the yield as compensation for work. The approval is sent to the three parties (e.g. from one of systems 160 or 170\to computer systems 150 of FIG. 1), and if they approve, three contracts are created, one for party A, for three acres with the same conditions. Only if the three contracts are all signed, per the smart contract technology, a joint contract is created between the harvester and the three people.

In other embodiments, the agreement does not have to have unanimous consent of the parties, if could be based on consent of, for example some fraction or threshold, e.g. two out of three, enough to represent 60% of the funds, etc.

In a blockchain implementation, virtual accounts and transactions may be posted to a blockchain that supports smart contracts, e.g. using computing systems as shown in FIG. 1. A VSA may be implemented as a smart contract, e.g. a special address on the blockchain with executable code attached to it. If the participants desire to perform an action, they may post (e.g. using computer systems 150) a transaction to this address which will in turn validate conditions as stated in the contract, and if the conditions are met, will allow a transfer, e.g., send the outbound funds after collecting them from participants. For payment authorization, a mechanism may be cryptographic, for example:
1) to authorize an outgoing payment from VSA, knowledge of a private key is required;
2) the private key is protected using an “m-of-n” cryptographic method, such as Shamir's Secret Sharing, or another secret sharing method. Each participant knows a single component, and there are total of N components. Any M participants can recombine the private key.

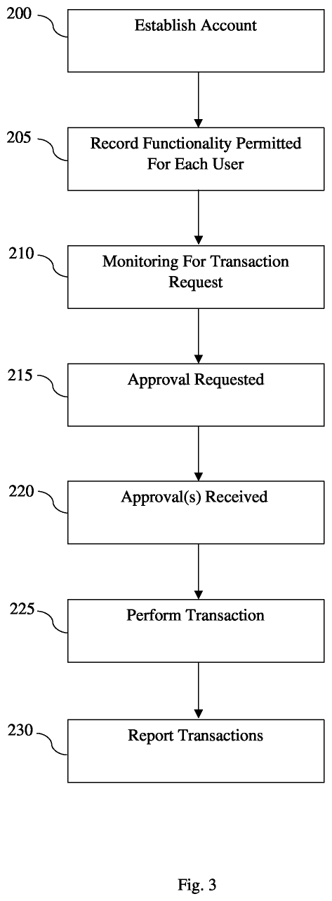

FIG. 3 is a flow chart of the establishment and use of a Virtual Split Account (VSA) or central account (e.g. operated by a managing node), according to some embodiments of the invention. The operations of FIG. 3 may be performed by a system such as shown in FIGS. 1 and 2, or other systems. In operation 200 an account such as a VSA may be established by and be accessible by at least one user or owner (e.g. operating associated transferring nodes). A VSA may be associated with a number of users or owners operating associated transferring nodes (e.g. computers, smart phones, etc.), such that each associated transferring node has an account associated with the node and user, and also with the VSA. Various settings for a VSA and for related sub-accounts may be chosen upon the establishment of the account, such as the division of receipt or transfer of resources, authorization, etc. Sub-accounts may inherit such settings, or a subset of such settings, from other accounts (typically from other accounts owned by that same user), and users may change such settings from the inheritance, such has having different limits on transaction, different authorization methods, etc. An account, and/or a managing node managing the account, may record, e.g. transfers between the associated entities, such as transfers of computing resources among computing entities.

In one embodiment a VSA may be implemented by an entity managing computer resources (e.g. a cloud computing organization), a bank holding the original account, by the credit card company, by dedicated apps or applications that are used to manage the account, or other entities. Such accounts may be created by, e.g. a user who has access to the account and needs an API (application programming interface) to inherit from the regular accounts, and permission to pay, and receive, etc. A VSA may be associated with computing entities (e.g. servers, desktop systems, etc.) each including or associated with computing resources (e.g. physically including such resources, owning or having rights to remote computing resources physically present in a cloud computing system, etc.) and a managing node comprising a processor:

In operation 205 the functionality permitted by each user may be received and/or recorded; such functionality, permissions and definitions may include the various portions assigned to each user, permissions, etc. This may be reflected, at least in part, in rules, which may govern or control accounts, or determine how transfers are conducted, determine what amounts or proportions of computing resources can be transferred (e.g. how much storage to be transferred), etc. In operation 210 monitoring may take place to establish when a transaction is requested. In operation 215 approvals or permissions in support of the requested transaction may be requested (e.g. permissions to transfer). The requirement for such permissions or approvals may be determined by a VSA, for example on setup. For example, a transfer may need approval from both of two parties linked to the VSA, which results in a request sent to both parties, where approval of the transfer only done only after it both parties approve; an alternate scheme is that approval is needed from either of the parties.

In operation 220 an approval from relevant users (e.g. each user or account holder, or some subset) may be received. Such approvals may be evaluated before being used or executed, e.g. by comparison with agreed upon protocols stored in a database. If the approvals received match criteria, or rules, the transaction may be approved (such a determination may be performed, e.g. by a managing node). For example, if a sufficient number or proportion, e.g. above a threshold, of associated transferring nodes grant permission, the transaction make place, e.g. by sending to each associated transferring node a request to transfer, in response to which each associate transferring node transfers. Approvals or permissions may be evaluated in various manners. For example, in one embodiment there may be a logical function on approval (A OR B OR C) may be a logical function indicating that only one out of three parties need to approve but more can; a logical function (A AND B AND C) is a logical function for the case when all parties need to approve. The logical function outputting true indicates overall approval for the transaction.

In operation 225 the approved transaction may be performed, e.g. controlled or coordinated by a managing node. This may involve computing devices transferring control of computing resources, e.g. one computing device communicating with a cloud system to allow another computing system to use an amount of storage resources operated by the cloud system, or data exchanges with another institution, e.g. clearing or settling the transactions with a financial institution. Initiating and completing the financial transaction may be contingent on or based upon the approval and protocol comparison matching or being satisfied. Setting up and performing the transaction may include a node performing determinations by creating and using a graph, or data analogous to a graph, as described herein. Setting up and performing the transaction may be according to rules, permissions and definitions, etc. For example, a rule may state what proportion of a transfer each associated transferring node is to transfer: for example, two owners or users may, per the rules governing a central account, be made such that each user pays 50 percent of the ultimate amount to be paid, and revenue received is allotted in a 40 percent/60 percent arrangement. The managing node or another system controlling transfers may effect a transfer between the associated transferring nodes and the first transferring node. Effecting the transfer may include, for example for each associated transferring node, the managing node either causing a direct transfer between the associated transferring node and the first transferring node, or a transfer between the managing node and the associated transferring node and between the managing node and the first transferring node. Transfers may include a transfer of resources such as funds, resources (e.g. computing resources), etc.

In operation 230 reporting of the transactions may occur; e.g. a selected time period reports may be provided and transmitted to the appropriate user(s). Other operations or series of operations may be performed. Shared accounts may be configured to make payments, receive payments or income, or both. Some accounts may not be set for receiving money at all, or set for receiving and not for payment. For example, three participants may have a business selling cookies, and when the business is paid the payments are sent ⅓ to each of the participants, where the account is not used for payments.

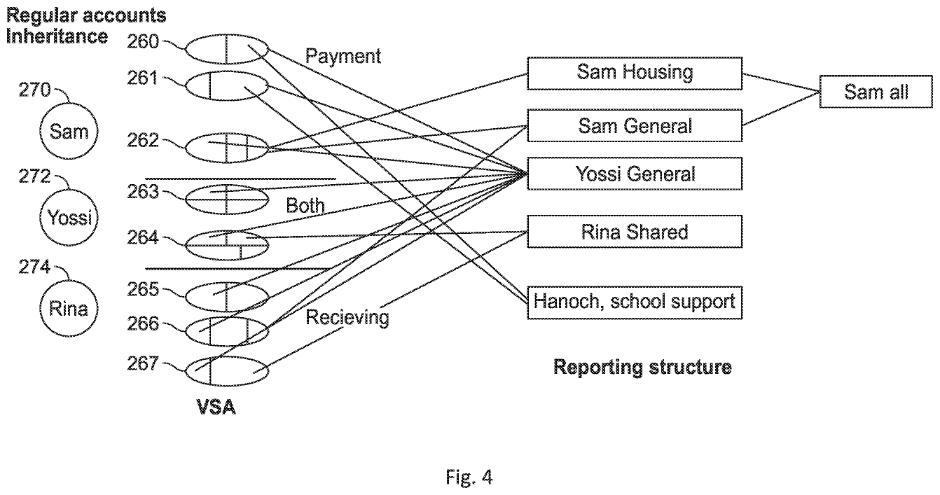

FIG. 4 presents an example information flow according to some embodiments. In one embodiment, each account 260, 261, 262, 263, 264, 265, 266, and 267 (e.g. a VSA or central account, which may be similar to central account 172 in FIG. 1) includes parts associated with a user account (e.g. local VSA accounts) among accounts 270, 272 and 274 (which may be similar to local accounts 152 in FIG. 1). Accounts may proportion payments or receipts according to rules. Accounts 260, 261 and 262 are “payment” accounts; accounts 263 and 264 are “both”, e.g. both payment and receiving, accounts; accounts 265, 266, and 267 are “receiving” accounts. VSA 260 may be a payment account, wherein the payments belong equally (e.g. equal proportions, according to a rule) to payment made by each of two users or user accounts 272 and 274. VSA 261 contains or is associated with two users or accounts 272 and 274 wherein the first user 272 has a larger percent (typically, the various percentages for users for categories such expenses or revenues add up to 100 percent for each account for each category). Account 263 may be a “both” account where both users 272 and 274 make equal payment proportions (e.g. based on a rule) but user 272 receives more of the income than user 274. Account 266 may receive income for all of users 270, 272 and 274. An account or VSA may be used for transactions such as payment of expenses, or for receiving of income, or for both payments and income. The split in percentage for the expenses may be different than the split in percentages for the income. The reporting structure may have multiple VSAs report to some joint reporting entity. This may also be hierarchical, in the sense that reporting may be for an account, or for an account and the account(s) from which it inherits characteristics, or, based on user choices, only accounts where a partner is a certain other person, etc. The report maybe to someone who has part of the VSA or to someone else.

Referring to FIG. 4, account 260 account is set up to pay expenses 50/50 (each party paying equally); authorization for payment may be needed by only one user, e.g. either of the two users (in other embodiments, a specific user may be required to authorize). When one of users 272 and 274 of account 260 authorizes, the full amount of the payment is removed exclusively from the account (a personal account separate from but linked to the shared account) of the authorizer. A first user authorizes payment and the money is now taken from that users account. Should the second user also authorize payment, the share of the payment is given to the user who paid. The first user is charged for the full amount. Should the second user authorize payment later, the second user is charged 50 percent of the amount and the first user is reimbursed for the 50 percent of the amount and is thus paid back for the earlier deducted payment. Should the second user not have sufficient funds in the account, the debt is recorded in the second user's account signifying that the money is still owed by the second user to the first user. The second user will have the owed payment deducted in the next transaction or when said user has money in the account, or at a certain predetermined date. This may also be performed by any number of users. Other specific orderings and arrangements may be used. In each example in FIG. 4, a management node or other entity may cause (e.g. effect) a transfer between the associated transferring nodes and their related accounts and a first transferring node and its related account, e.g. an entity receiving funds.

In example account 262, three users may set up VSA or central account, e.g. managed by a managing node, to pay costs. The payment apportionment is allotted in a 50 percent/30 percent/20 percent apportionment among users 270, 272 and 274. In one embodiment, payments must be approved by all three users. When payment is required, money is collected from each of the three users 270, 272 and 274 in the agreed upon apportionment. When each of the three amounts are approved, the transaction is performed. In one embodiment there is no transaction or deduction if one user does not approve, or does not have the money in the users account.

In example account 264, two users may be joint partners in a company where both users provided the startup capital, but the first user does more work than the second user. The example agreement is that the payment is made in a 50 percent/50 percent arrangement. However, the revenue received is allotted in a 40 percent/60 percent arrangement: this can be seen in the line dividing account 264 (above the line, payment, below the line, receiving). Further, the first user may have one VSA used for both spending and revenue collection. The second user may have two separate VSA, one VSA for spending and another separate VSA to received deposit revenues as collected. Thus the two users have three separate related VSA's.

In another example account arrangement, a user may have multiple associated VSA's. The user's VSA receives money physically deposited into the VSA by another person. This depositor is able to monitor the spending activity of the user through monitoring the VSA. Thus the user has permitted the depositor to participate in the reporting functionality and structure of the VSA.

In another example, a first user may establish a first VSA account for use with a second user for the purpose of splitting costs. The VSA is set such that each user may authorize payments to a vendor that offers discounts where permission is granted automatically for expenses less than $100. A second VSA is established for two different and separate users in the fifth example scenario. The second VSA may reuse or inherit software functionality or settings from the first VSA. Such reused software may include authorization personal user input.

In some embodiments, after authorization a permission is received, according to the rules or scheme of who can grant permission depending on the embodiment it may be decided how transfers are to take place. Rules or schemes may include, e.g., everyone, one, or any subset must give permission (this may depend on the amount), in order to determine that the transaction may take place. For example, if a sufficient number or proportion, e.g. above a threshold, of associated transferring nodes grant permission, the transaction takes place. This rule-based process may start by asking for permission, and waiting for a reply until a permission is given. For example, in one embodiment if the transfer is under a threshold such as $50.00, lower authorization is required, e.g. the permission of one participant is enough, where if the amount is in a different threshold range, e.g. $50-$100, a majority (e.g. above a 50% participant threshold) is needed, and above another threshold such as $100, all must give authorization for the transfer to take place.

Once authorization or permission is established, e.g. via a managing node or a different computing device, various options exist for transfer or payment. The account, e.g. managed by the managing node, may automatically ask those associated with the account (e.g. operating associated nodes) for transfers (e.g. of money), and all associated with the account pay; the account sends requests for funds, and after it gets all the replies (which may be a fast process) it forwards the total amount to an account managed by a first transferring node. In another embodiment, after authorization exists, only some participants (e.g. operating associated nodes) transfer or pay, and afterward there is reconciliation such that only those who gave the permission pay and those who did not give permission pay back those who gave permission. This can be proportional or any other scheme.

Without costs for transactions, each person associated with a central account or VSA needs to pay their share in the joint account. However, due to for example economic regulations, there may be fees and transaction costs when money is moved from one account to another, and also amounts paid to payees, e.g. cashback or rewards. In one embodiment these costs or payments are solved from the point of view of the account or VSA, e.g. by the managing node which manages or controls the account or VSA. For example, the first transferring node (e.g. merchant controlling a merchant account; while a merchant is used as an example party receiving funds from a central account funded by members, other parties may be paid in this manner) may give a discount depending on how money is paid. Currency and currency translation fees may occur. Each account may have multiple ways to transfer to or pay another account. One could be a flat transaction fee, another could be proportional transaction fees, and the method chosen can be dependent on for example amount, currency, and specific transaction parameters.

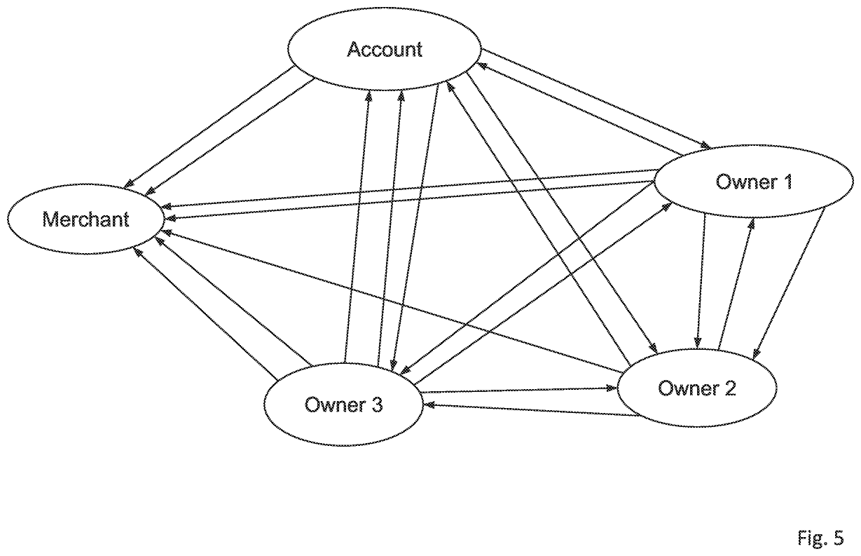

FIG. 5 is a graph depicting example payments to a first transferring node, e.g. a merchant controlling a merchant account. Referring to FIG. 5, while arrows are shown to the merchant, if the merchant pays the account or others, graph edges will go from the merchant to the account (e.g. operated by a managing node) or owners (e.g. operating associated transferring nodes). In one example, if owners 1-3 need to pay $50.00 each to the merchant, without optimization, the following example greedy algorithm may be used:
1. Account (e.g. managing node) finds the cheapest way to pay $150.00 to the merchant (out of the possible ways), then split the request among the owners (e.g. $151.00 ($1 for service) split to $50.33)
2. Owner 1 finds the cheapest way to pay account what is owned, money and transaction from owner to account (out of the possible ways); Same for owners 2 and 3.

In one example optimization method (e.g. first order optimization), a direct payment is made to a merchant. The account (that does the optimization, e.g. the managing node) may check for each owner, if it is cheaper to pay the merchant directly with the best way it has to pay) than via a VSA or central account. If yes, for example for owner 2, owner 2 pays merchant $50.00 in the cheapest way, and owner 1 and owner 3 pay the account $50 each, and the account pays the merchant $100.00.

A process for such an embodiment may be:
1. For each owner
   a. Check how much the owner needs to pay (how much needs to get to the merchant)
   b. Compare paying directly to the merchant, or through the account
   c. Choose the cheapest way

Pseudocode for such a process may be:

Let O::={o₁, . . . , oₙ} be the list of owners, A::={a₁, . . . , aₙ} the list of amounts each owner is due to the merchant.

Let P_{direct} (o, a) and F_{direct} (o, a) be the percentage and the fixed costs of owner o paying amount a directly, and P_{account} (o, a) and F_{account} (o, a) be the cost of owner o paying amount a via the account.

```
for t = 1, ...n do:
  if F_{direct} (oₜ, aₜ) +aₜ*P_{direct} (o, a) <
F_{account} (oₜ, aₜ) +aₜ*P_{account} (o, a)
  then
    / / prefer direct payment
  else
    // prefer payment via the account
  end if
end for
```

In one example local optimization method (e.g. second order optimization) a search may be made for the cheapest path from each account to merchant. The cheapest path may be through other owners, for example via a process such as:
1. For each owner
   a. Check how much the owner needs to pay (how much needs to get to the merchant)
   b. Look for the cheapest path from owner to merchant, the one in which the owner pays least
      i. Transfer the money using this scheme.

Example pseudocode for such a process may be:

Let O::={o₁, . . . , oₙ} be the list of owners, A::={a₁, . . . , aₙ} the list of amounts each owner is due to the merchant.

Let P_{i,j} (o, a)::={p_{1,j}, . . . , p_{m,j}} be the percentage cost along path j, and F_{i,j} (o, a)::=={f_{1,j}, . . . , f_{m,j}} be the fixed cost along path j, and let Nₚ be the total number of paths.

Let T::={t1, . . . , tn} be the target path for each owner.

```
for t=1, . . , n do:
  Cₘᵢₙ := +Infinity
  Tₜ:=0
  for j=1, ... , Nₚ do:
    C = Σᵢ₌₁^{m}(P_{i,j} × aₜ + F_{i,j})
    if Cₘᵢₙ<=C
    then
      Cₘᵢₙ := C
      Tₜ := j
    end if
  end for
end for
```

Another local optimization method may include:
i. Given a payment request for the VSA, evaluate all payment avenues, choose the payment avenue available to the VSA which costs the least. For example, if it has two payment means one that cost 1% and one that cost $1 and the need to pay is $50 it may choose the 1% option so the payment is $50.5.
ii. For all accounts:
   1. calculate how much the account needs to pay (for example, if $40, than $20.20 for an account owing 50%)
   2. Choose the payment avenue from the account to the VSA that is the cheapest for this amount.

In one example algorithm, if a central account or VSA managed by the managing node needs to pay the merchant $100.00, and the cheapest way based on transaction costs is $1.00, one option may be 1% and the other $2 and for the amount the first is chosen. So the account needs to obtain $101 from its owners or associated nodes. The first and second owner may each transfer $50.50. The cheapest method for owner 1 to transfer may cost $1.00 so owner 1 may transfer $51.50. Owner 2 may have a cheapest transfer method of % 0.8 so the second owner may transfer $51.30 to the account.

In a second example algorithm, for the first owner the cheapest way is to transfer directly, so he pays the merchant $50.80. The second owner now needs to pay the entire cost of the account, 1%, of the $50 that will go through account so its fees are 0.8+0.5 and needs to pay $1.30 In some embodiments, entities may pay through the VSA or directly, not using the VSA, and each party may chooses the best method for that party. If a direct payment is made, the merchant may receive what is paid minus the costs of transaction. In some embodiments, optimizing over the total fees is not the same as each optimizing for one party.

In a third example algorithm, it is cheapest for owner 2 to pay through owner 1. Owner 1 needs to pay $100.80, which will be paid by owner 1 and owner 2. If they split the fees equally each pays $50.40; if it is not possible then owner 2 pays $50.80 and owner 1 pays $50.00. It may be that fees are paid equally, or fees are paid by those with who use the other's account.

The various methods of payments may be a parameter of the central account.

Embodiments of the present invention may provide an account with inheritance. For example, a VSA may inherit or reuse software modules, classes, objects and the like to implement multiple functions. Such reuse is appropriate when functions use similar processes, procedures, or data. Such functions include, but are not limited to site registration, login, user validation and user authentication. Such inheritance may be hierarchical such that a function used in a first application may inheriting the functionality from another application. Local accounts, or VSA accounts, may also use inheritance. For example, if user A has an account, which may be for example a typical bank account, the user may create “under” or depending from this account a local account (e.g. a local VSA account) to be used for, for example, payments to restaurants. Under or depending from the local account for restaurants, the user may create are other local accounts, for example, one to be used with user B (e.g. named “with-B”) and another to be used with user C (e.g. named “with-C”). VSA or local accounts may inherit characteristics from the accounts they are under or depend from. For example the “restaurant” account, depending from user A's “regular” account, inherits characteristics from the regular account and when a payment is made from the “restaurant” account, it is paid from the higher level regular account. Characteristics inherited from an upper higher account may include for example, user authentication, (e.g. password and biometric), a limit (e.g. of $300) per transaction; these characteristics apply to the accounts under or beneath this account. In this example, with-B and with-C inherit from the restaurant account, which means that they have the same user authentication by default (unless changed) and the same payment options (which are the payment options of the account). Defaults or inherited characteristics in lower level accounts may be changed. For example, a different limit may be set for with-B, e.g. $50.

In some embodiments, a VSA may be used with one party payment if the VSA provides improved functionality, e.g. improved reporting for the paying party.

In some embodiments, a VSA may be used with one party payment if the VSA provides improved functionality, e.g. improved reporting for the paying party.

Each VSA may be associated with a number of local accounts (e.g. local VSA accounts), each local account associated with a corresponding user-associated transferring node pair. Each local account may inherit many properties from a “real” account it is part of where the real account is associated with a user operating an associated transferring node. For example, if person A's split of a VSA account (e.g. payment for apartment) is part of that person's regular bank account R (a local account), then registration, validation and many other things that are not signified as different will, for the local account, inherit from account R. Funds may enter account R and exit out of R through the local account and VSA.

Inheritance may be hierarchical with one VSA account, or user local account, inheriting from another.

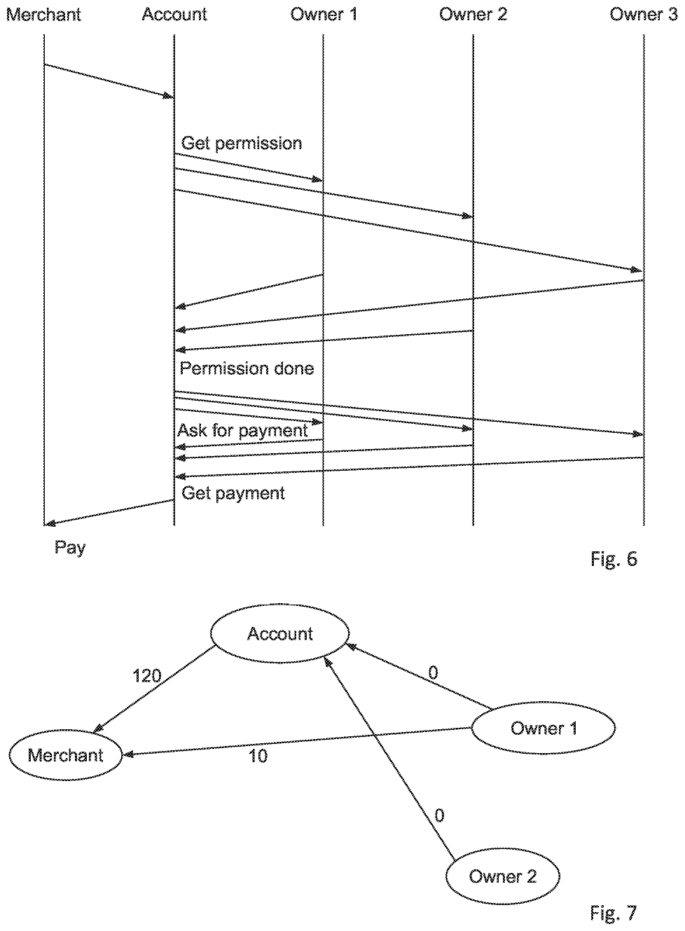

FIG. 6 depicts communications among entities according to embodiments of the invention. The operations of FIGS. 3 and 6 may be performed by a system such as shown in FIGS. 1 and 2, or other systems. Referring to FIG. 6, a merchant operates a first transferring node maintaining an account, receiving funds from an account operated by a managing node, or directly from associated transferring nodes operated by Owner 1, Owner 2 and Owner 3. Referring to FIG. 6, a merchant may request payment from the Account managed by a managing node, which in turn may ask permission from Owners (“get permission”); when sufficient permission is received (“permission done”), the managing node may ask payment from associated transferring modes operated by Owners, which may provide payment to the Account or directly to the merchant. A management node or other entity may cause (e.g. effect) a transfer to, e.g. pay, using funds from associated transferring nodes and their related accounts, a first transferring node. While FIG. 6 depicts payment from owners to an account, and then to a merchant, effecting the transfer may include, for each associated transferring node, the managing node causing a direct transfer between the associated transferring node and the first transferring node (e.g. between owners and a merchant directly), or, as shown in FIG. 6, a transfer between the managing node and the associated transferring node and between the managing node and the first transferring node (e.g. among accounts associated with these nodes).

In one embodiment, all Owners operating associated transferring nodes must decide or grant permission: in this kind of messaging scheme, when the account needs to pay, it gets permission from all members for their share, once it has permission from all, then it requests payment, and payment is done. If one does not give the permission, then payment will not happen. In one embodiment, partial decision of Owners operating associated transferring nodes may occur. In this scenario, when the account asks for money, the payment is automatic without permission. However, for the account to ask for money, approval is needed. The approval could be in many ways, for example: Anyone can approve (any member); Majority can approve (majority can be of the people or of the money); a Specific person approves. Once the approval cycle is done in any embodiment, request for payment is sent which is paid automatically.

In an example where anyone (e.g. any owner) can approve, if Owner 3 approves, then a payment request may be sent by a managing node and payment is made. Approval may need permission, and payment is automatic but may be limited in different ways (amount, geography, etc.). In another example where the approval is by majority, of Owner 1 and Owner 3 out of three owners approve, payment will be made by all via the Account.

Payment or transfer may be made automatically if there is default permission, or no permission required, based on settings, or if prior permission has been given. In one example, a VSA account for paying may have settings such as if one of the account participants authorize, payment may take place, only if the amount is under 50$.

In an example with a partial decision, where reconciliation is done, a portion of the associated transferring node Owners (e.g. a partial group) may decide, and only those in the partial group (one or more) pay. Reconciliation may be performed for the payment. Automatic authorization for the account to pay may exist, and when payment is done, it is done only by those who authorized. For the rest, when they will pay, if they will pay, it will be to the people who already paid rather than the merchant or other payee.

In another example, three people control associated transferring nodes and associated accounts, where each can decide to approve (e.g. partial decision) and when a person decides payment is done, the other two will pay to her when authorized. After one authorization, overall authorization is complete, and the next stage is moved to. A request for payment arrives, e.g. a payment from owner 1 to the merchant, and owner 2 and owner 3 to owner 1. The payment from owner 2 to owner 1 can be for example direct (e.g. the owners' personal accounts exchange funds) or indirect (e.g. exchange is performed from a VSA).

In a further example, majority authorization is required. If owner 1 and owner 3 gave permission but owner 2 did not, in a next stage, various reconciliation schemes are possible. In one arrangement, owner 1 and owner 3 pay proportionally and owner 2 is requested to pay both of them when it authorizes. Another configuration option may determine who pays for owner 2: for example owner 1 may pay for owner 2 and owner 2 pays back only owner 1. Other options are possible.

Such schemes may use local optimization, lowering fees for certain individuals, and may result in higher total fees or higher fees for one person. For example, if the payment from a central account to merchant was $1 instead of 1%, then in one example given above payment would be $50.80 for the first owner, and $51.80 for the second owner, which means higher payment for owner 2 If direct payment for the first owner was $1.20, and payment from account, then first algorithm stays the same and second becomes $1.20 for first owner and $1.80 for second owner which means higher total fees for the second compared to the first.

Global optimization may be used to reduce total fees or expenses across all parties or all owners of a central account. The division of the total fees among owner may be decided by owners, for example proportionally, or by value of discounts that the accounts have. FIG. 7 depicts a graph describing example payments to a first transferring node, e.g. a merchant controlling a merchant account. In FIG. 7 the fee graph shows a merchant owed $120 total, with $120 paid via a VSA and $10 in fees paid from owner 1, with owner 2 not paying anything, but owing owner 2. The entities have chosen to transact this way instead of having both owners paying via the VSA or owner 2 paying some portion directly.

Various embodiments may solve optimization in different ways. E.g.: the central account or VSA may pay $220 ($100+$120 fees) and receive $110 from owner 1 and $110 from owner 2 (total fees $120). In another example owner 1 pays $60 directly to the merchant, such that the merchant receives $50 from owner 1, after a reduction in $10 fees (e.g. transaction fees); owner 2 pays $170 due to paying $120 in fees. In this case the total fees are $130, worse than the previous option 1: better for owner 1 but worse for owner 2. In another example, owner 1 pays $110, owner 2 pays nothing; total fees are $10, and owner 2 did not pay.

Embodiments may perform global optimization to reduce total fees and introduce reconciliation between partners in the account. Global optimization may reduce cumulative transferring costs for all transferring nodes. Further, local optimization may be performed to, for each node, reduce transferring costs for that node without consideration of other nodes. In one embodiment a global optimization algorithm may start with each owner transferring the amount due to him (for example if the owner needs to pay one third and the total is $150, dedicating $50) and the merchant due the total amount. Then an embodiment may operate to increase the amount paid by the owner such that the increase is the minimum in total. The calculation may be explained with respect to a graph. If the merchant is due $X, the edges in the graph going in towards the merchant should total $X (with a minimum on transaction fees or costs). The restrictions may be (where the value of edge from central account or VSA+the value of edges from all owners=100), minimize total or cumulative transaction cost. Then for the central account (e.g., VSA) a calculation may be made: amount or value of all edges going from the VSA to the merchant=amount from VSA+transaction cost from the VSA. In one embodiment the system described may look for the best solution using, for example a constraint satisfaction problem (CSP) to be solved using known constraint satisfaction methods. The constraints come from the nodes: the total amount that needs to get to the merchant, and the amount going in into each node, equal the amount going out. For example, the amount going in to the merchant is the amount to be paid, this is split on the edges going in; the same may hold for all other nodes. The minimization may be on the transaction costs or fees, e.g. the cumulative or total fees. Another constraint is minimum amount paid by each owner (its share), which may be a local or global optimization. After this problem is solved, how much each person is to pay is known. A constraint may be added such that the amount of fees is as similar as possible. This may solve the problem for the case that payment is done by all parties and there is no later reconciliation (e.g. shifting of payments among parties after a payment is made to a merchant).

In one embodiment, pseudocode for a global optimization algorithm may for example: Definitions:
Let Vᵢ be the vertices of the graph.
Let E_{i,j} be the edges of the graph where node E_{i,j} connects vertex Vᵢ to vertex Vⱼ.
Let, further, each edge E_{i,j} be a list of cost options E_{i,j}::={e_{i,j,1}, . . . , e_{i,j,n}_{_{i,j}}}, where n_{i,j} is the number of cost options between vertex Vᵢ and vertex Vⱼ.
Let each cost option e_{i,j,k} be a pair e_{i,j,k}::= [symbol] p_{i,j,k}, f_{i,j,k} [symbol] , where p is the percentage and f is the fixed cost.
Under the above notions, the cost to transfer an amount A between nodes Vi and Vj can be one of the following: {A×p_{i,j,1}+f_{i,j,1}, . . . , A×p_{i,j,n}_{_{i,j}}+f_{i,j,n}_{_{i,j}}}.
Let further define Oᵢ to be owners and Mᵢ to be merchants, such that {Oᵢ}⊂{Vᵢ} and {Mᵢ}⊂{Vᵢ} are subsets of the graph vertices, with N_{O} and N_{M} being the number of owners and the number of merchants.
Let μᵢ be the minimum amount for the owner Oᵢ to pay.
Under these notions, a possible solution to the problem would include:
   List of amounts A::={a₁, . . . , a_{N}_{_{O}}} such that ∀i=1 . . . N_{O}, aᵢ≥μᵢ and Σᵢ₌₁^{N}^{_{O}}aᵢ=Aₜₒₜₐₗ, where Aₜₒₜₐₗ is the total amount to pay.
   A subgraph S⊂{Vᵢ, E_{i,j}} such that ∀i. aᵢ>0. Oᵢ ∈ S
   A set of edge preferences I={I_{i,j}} denoting the index of the preferred edge option between vertices Vᵢ and Vⱼ
The total of transaction fees for such a solution may be computed as follows:

```
Let X ::= {Oᵢ} where aᵢ > 0
Let [symbol]   denote the cost of the solution [symbol]   A, S, I [symbol]
repeat
  A′ ::= { }
  X′ ::= { }
  for each Vᵢ ∈ X
    if Vᵢ ∉ {Mᵢ}:
      for each edge E_{i,j} ∈ S such that E is outbound from Vᵢ:
        X′ ::= X′ ∪ {Vⱼ}
        if aⱼ ∈ A′ then
          aⱼ ::= aⱼ + aᵢ
        else
          aⱼ ::= aᵢ
        end if [symbol]
        ::= [symbol]   + aᵢ × p_{i,j,I}^{_{i,j}} + f_{i,j,I}^{_{i,j}}
      end for
    end if
  X: :=X′
  A: :=A′
  end for
until X = Ø
```

The optimization criteria may be set, for example to:
   [symbol] →min—minimize total fees
   [symbol] →min, Var(A)→min.—minimize total fees while striving for an equal distribution of amounts between owners.
A constraint satisfaction method may produce a solution, an amount that will be taken from each account as well as the routing of the money to the merchant.

In one embodiment, a global optimization algorithm may, for example, include the following:
Let M₀=V_{N+1} be the VSA account, and V₁, . . . , V_{N} be the participating entities. Let A be the total amount due.

for i = 1, ... , N do:
Sᵢ ::= {V₁, ... V_{N+1}} ∪ { E_{i,N+1}} ∪ {E_{j,i}|j = 1, ... , N, j ≠ i}
${A}_{i} \text{::=} \{ {a}_{j} = \{ \begin{matrix}A , & if j = i \\ \frac{A}{N} , & if j \neq i\end{matrix} , j = 1 , … , N \}$
Iᵢ ::= {I_{i,j} such that p_{j,i,I}_{_{j,i}} × aⱼ + p_{j,i,I}_{_{j,i}} is the smallest}
end for
Compute [symbol] for each I, as above.
Use [symbol] Sᵢ, Aᵢ, Iᵢ [symbol] for which the value of C is minimal.

In one embodiment, a global optimization algorithm may for example:
Set constraints: e.g. create or describe graphs as depicted herein in the language of constraints.
   Set amounts that goes in into a node as the total of the amount of edges going into a node.
   Set transaction costs or fees as being added on payment from nodes X to Y
   There may be multiple edges between two nodes in the graph with different cost. For example, transaction fees for one node could be 1% and another $2.
   Set the amount that needs to go in to the recipient (e.g. merchant) and the minimum amount paid by each owner.
The optimization criteria may be set, for example to:
   Minimize total transaction fees.
   Aim for similar payment of transactions between owners.
A constraint satisfaction method may produce a solution, an amount that will be taken from each account as well as the routing of the money to the merchant.

In one embodiment, a global optimization algorithm may for example:
i. For N+1 entities (N entities participating in the VSA; and the VSA account itself)
ii. Evaluate using a local algorithm paying through the entity chosen or through the VSA
iii. For each account:
   1. Make payment from each account (in the cheapest avenue it has) and the other accounts pay it back (with the cheapest avenue they have)
iv. There are N+1 options, find the option with the lowest total transaction cost:
   1. choose that option

An account such as a VSA may employ a reporting structure in which participants in the VSA may decide which participant or which multiple participants receive generated reports. Reporting may be organized by geographic locations such as in the context of house expenses. Multiple people may receive the same reports. Multiple people may also receive customized reports. Reports may be distributed based on permissions established by the account owners. A VSA or other account may enable participants to pay expenses according to a split percentage, equal or unequal proportions. Such an example may include, for example, an equal 50 percent/50 percent apportionment or a 50 percent/40 percent/10 percent apportionment among participants, or another suitable split. A VSA may enable participants to receive or share revenues such that the account performs a revenue distribution, e.g., according to a split percentage, e.g. an equal 50 percent/50 percent apportionment, a 50 percent/40 percent/10 percent apportionment, or another split. For example, three users may each pay ⅓ of some expense each. Three other users may collect ⅓ of the expenses each, or for each side an arrangement other than a ⅓ each. Users may share revenues in the same proportions as they share expenses, or in different proportions.

Authorization schemes may govern or detail how expenses are authorized; such schemes may need to be agreed upon by all relevant users. In some arrangements, all users will be required to authorize an expense; in other arrangements, a majority or another portion can authorize an expense. In other arrangements, one can authorize an expense that all will incur. Some schemes allow authorization to be required from party A but not party B to the same account. Upon authorization by a first user, that user may have the entire amount deducted from their account. When subsequent users authorize, the proportional amount may be deducted from their accounts and these funds may be used to reimburse the first user. Automatic validation and authorization may be agreed upon regarding expenses below a certain threshold currency amount or to a certain business or a certain type of expense. Expenses may also be authorized for specific business purposes. In one embodiment, expenses may only be authorized in specific geography areas.

Inter-account settlements may be performed: for example a first user authorizing a payment but lacking sufficient funds or credit to make a payment for an expense may still authorize a payment. This expense may be recorded and the first user's account will owe the other accounts in the VSA. This expense may be settled at a later date. Settling an owed transaction expense may be made at the next payment schedule, or whenever the funds become available to the account or on a specific date. The settlement may not be made at all due to lack of funds

One user may create a specific VSA with a business that agrees to provide a discount to the user. In such a case the business may agree to pay a portion of the expense in the VSA. This may be considered to be similar to giving the user a discount for using the specific business attached to the VSA. Multiple users may be associated with the VSA and such users would also receive the same discount.

In one embodiment, an account such as a VSA may be operated via a lottery where some or all of the revenues, expenses or both are apportioned based on a random selection of users. An account may rank users based on credit score and weight the approvals proportion, payment proportion or approved purchase amount based on credit score. An account may enable a buyer's regret mode such that one or more users may cancel their approval after a preset amount of time.

An account or transfer method in some embodiments may be used to, for example, allow a number of associated transferring nodes associated with an account, where each node is operated by a roommate, to pay for roommate associated expenses, e.g. 50/50 (each number being a percent of expenses borne by each person associated with a transferring node); allow three friends to pay for a car they share 50/25/25; allow 15 people to pay for a lottery ticket equally and receive winnings equally; and in the case of two restaurant partners, paying 50/50 but for receiving earnings, splitting 60/40.

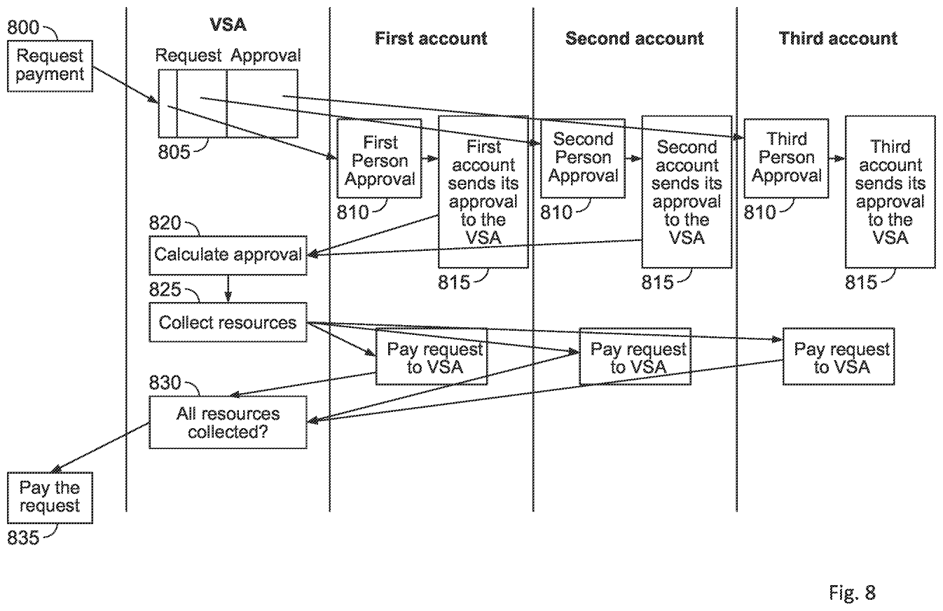

FIG. 8 depicts communications among entities according to embodiments of the invention. The operations of FIG. 8 may be performed by a system such as shown in FIGS. 1 and 2, or other systems. In operation 800, a request for transfer (e.g. payment, although other transfers may take place) is given to the VSA (e.g. account 172 in FIG. 1). For example, a request for a transfer of $100 may be sent. In operation 805, a request for approval may be sent from the VSA or note 170 in FIG. 1 to all or a subset of the accounts associated with it (e.g. to computers 150 controlling accounts 152 in FIG. 1). In this example shown in FIG. 8 it is sent to all members, to each according to the amount they should pay, but other schemes are possible. In this example, the first request is for $20, the second for $30 and the third for $50 (all together $100). In operation 810, the various entities associated (e.g. computer systems 150 in FIG. 1) may be presented with a request for approval; for example people involved with the particular VSA may receive the request on a user interface (UI) executed by a computer 150 and some or all may approve. In operation 815, approval may be sent by, e.g. devices 150 to the VSA (e.g. to computer 170 operating a central VSA). In the particular example shown, a first entity and second entity approved, and a third did not (yet).

In operation 820, after approval is received by the VSA, it checks for appropriate (e.g. total) approval, for example in accordance with pre-defined criteria. Such criteria may include, e.g. only one party needs to approve, all need to approve, two need to approve, a specific two need to approve, etc. In the specific example shown, it is either one and two, or three (so that at least 50% provide approval). In one embodiment, each time a VSA receives one approval, it may re-check if the overall approval becomes true. In the example shown, if at least two approve, the formula becomes true, so the formula becomes true (overall approval is reached) after one and two approves.

In operation 825, once overall approval is true, the VSA moves to collect the transferred items (e.g. goods, computer resources, money, etc.). In the example in FIG. 8, the VSA transmits to the three accounts a collection request, which in operation 830, will effect a transfer (e.g. send payment) automatically unless there is some issue. In one example, transfer is performed automatically if the received transfer is less than $200, and in the example of FIG. 8, all send payment. In operation 835, once the VSA receives the transfers or payment, if it has enough of the required items to transfer or goods, it will transfer or pay the original requestor. In some embodiments, if, before the exchange or transaction is completed, any participant or account disagrees, than the transaction may be aborted and if goods or transferred items (e.g. money) has been moved to the VSA account, it is returned to the relevant accounts. A participant disagreeing may be different than a participant not approving: not approving may be where a participant simply does not respond with an approval, while disagreeing may be an active communication that the participant does not want to proceed with the transaction or transfer.

Embodiments of the invention provide a practical, real-world improvement to the technology of blockchain and smart contracts, which provide a technology solution which may keep track of ownership or funds. For example, embodiments may allow for easier group distributed decision making among computer devices controlling accounts. Embodiments may improve attribution or reporting, e.g. if a VSA is used to track transfers.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method comprising:
in a computer system comprising a plurality of associated transferring nodes each comprising processors: a first transferring node comprising a processor; and a managing node comprising a processor:
determining, based on a rule governing an account associated with the associated transferring nodes, what proportion of a transfer each associated transferring node is to transfer:
the managing node effecting a transfer between the associated transferring nodes and the first transferring node.

2. The method of claim 1, comprising performing one of global optimization to reduce cumulative transferring costs for all transferring nodes: and local optimization to, for each node, reduce transferring costs for that node without consideration of other nodes.

3. The method of claim 1, comprising, at the managing node, requesting permission to transfer from each of the associated transferring nodes, and if a sufficient number of associated transferring nodes grant permission, sending to each associated transferring node a request to transfer, in response to which each associated transferring node transfers.

4. The method of claim 1, wherein effecting the transfer comprises, for each associated transferring node, the managing node either causing a direct transfer between the associated transferring node and the first transferring node, or a transfer between the managing node and the associated transferring node and between the managing node and the first transferring node.

5. The method of claim 1, comprising recording a transfer on a blockchain structure.

6. The method of claim 1, wherein the transfer is embodied in a smart contract.

7. A system comprising:
a plurality of associated transferring nodes each comprising processors; a first transferring node comprising a processor; and
a managing node comprising a processor, the processor at the managing node configured to:
determine at the managing node, based on a rule governing an account associated with the associated transferring nodes, what proportion of a transfer each associated transferring node is to transfer;
effect a transfer between the associated transferring nodes and the first transferring node.

8. The system of claim 7 wherein the processor at the managing node is configured to perform one of global optimization to reduce cumulative transferring costs for all transferring nodes; and local optimization to, for each node, reduce transferring costs for that node without consideration of other nodes.

9. The system of claim 7 wherein the processor at the managing node is configured to request permission to transfer from each of the associated transferring nodes, and if a sufficient number of associated transferring nodes grant permission, send to each associated transferring node a request to transfer, in response to which each associated transferring node transfers.

10. The method of claim 1, wherein effecting the transfer comprises, for each associated transferring node, the managing node either causing a direct transfer between the associated transferring node and the first transferring node, or a transfer between the managing node and the associated transferring node and between the managing node and the first transferring node.

11. The system of claim 7, comprising recording a transfer on a blockchain structure.

12. The system of claim 7, wherein the transfer is embodied in a smart contract.

13. A method of managing computerized resources comprising:
in a computer system comprising a plurality of computing entities each comprising computing resources and a managing node comprising a processor:
determining, for each of the plurality of computing entities, based on a rule governing an account associated with the plurality of computing entities, a proportion of a transfer of computing resources to transfer, wherein the account comprises a record kept in a blockchain structure;
transferring, by at least one of the plurality of computing entities, the proportion determined for each of the associated entit[y]ies based on the account, wherein the transferring comprises executing the blockchain as a multi-party computation, wherein in the multi-party computation, each entity of the plurality of computing entities does not receive information from other entities of the plurality of computing entities;
using an amount of the transferred computing resources by one of the computing entities; and
the managing node recording in the account a transfer between the associated computing entities.

14. The method of claim 13, where the resources comprise one or more of processing resources; memory resources; and storage resources.

15. (canceled)

16. The method of claim 14, wherein the computing entities are remote from a cloud computing system, the cloud computing system comprising the computing resources.

17. The method of claim 13, comprising performing one of global optimization to reduce cumulative transferring costs for all computing entities; and local optimization to, for each computing entity, reduce transferring costs for that computing entity without consideration of other computing entities.

18. The method of claim 13, comprising, at the managing node, requesting permission to transfer from each of the associated computing entities, and based on one or more of the computing entities granting permission, sending to each associated computing entity a request to transfer, in response to which each computing entity transfers.

19. The method of claim 13, comprising recording a transfer on a blockchain structure.

20. The method of claim 13, comprising recording a transfer on a smart contract.
